(19) United States
(12) Patent Application Publication
(10) Pub. No.: US 2021/0398419 A1
(43) Pub. Date: Dec. 23, 2021

(54) METHOD, APPARATUS, AND DEVICE FOR TESTING TRAFFIC FLOW MONITORING SYSTEM

(71) Applicant: Apollo Intelligent Connectivity (Beijing) Technology Co., Ltd., Beijing (CN)

(72) Inventor: Yuan CHI, Beijing (CN)

(21) Appl. No.: 17/463,620

(22) Filed: Sep. 1, 2021

(30) Foreign Application Priority Data
Mar. 5, 2021 (CN) 2021102447077

(51) Int. Cl. G08G 1/01

(52) U.S. Cl. CPC G08G 1/0145; G08G 1/0116; G08G 1/0133

(57) ABSTRACT

The present application discloses a method, an apparatus, and a device for testing a traffic flow monitoring system, which relates to intelligent traffic, vehicle-road collaboration, and cloud platform technologies in the field of data processing. The specific implementation is: monitoring and processing first obstacle data through the traffic flow monitoring system to obtain a first monitoring result, where the first obstacle data is collected in a real traffic scene; generating second obstacle data according to the first monitoring result, and monitoring and processing the second obstacle data through the traffic flow monitoring system to obtain a second monitoring result; where the second obstacle data includes data of an obstacle monitored in the first monitoring result; and determining whether a monitoring accuracy test of the traffic flow monitoring system passes according to the first monitoring result and the second monitoring result.

### CROSS-REFERENCE TO RELATED APPLICATIONS

The present application claims priority to Chinese application number 2021102447077, filed on Mar. 5, 2021, which is incorporated by reference in its entirety.

### TECHNICAL FIELD

The present application relates to intelligent traffic, vehicle-road collaboration, and cloud platform technologies in a field of data processing and, in particular, to a method, an apparatus and a device for testing a traffic flow monitoring system.

### BACKGROUND

In an architecture of an intelligent traffic system, an on board device and a roadside device collect obstacle data on a road, and report the obstacle data to a traffic flow monitoring system. The traffic flow monitoring system monitors and processes the obstacle data, so as to realize a monitoring of a traffic flow.

The traffic flow monitoring system needs to be tested before it goes online to verify whether a monitoring accuracy of the traffic flow monitoring system meets the requirements.

However, how to test a monitoring accuracy of the traffic flow monitoring system is a technical problem to be solved urgently.

### SUMMARY

The present disclosure provide a method, an apparatus and a device for testing a traffic flow monitoring system.

In a first aspect, a method for testing a traffic flow monitoring system is provided, including:

monitoring and processing first obstacle data through the traffic flow monitoring system to obtain a first monitoring result, where the first obstacle data is collected in a real traffic scene;

generating second obstacle data according to the first monitoring result, and monitoring and processing the second obstacle data through the traffic flow monitoring system to obtain a second monitoring result; where the second obstacle data includes data of an obstacle monitored in the first monitoring result; and

determining whether a monitoring accuracy test of the traffic flow monitoring system passes according to the first monitoring result and the second monitoring result.

In a second aspect, an electronic device is provided, including:

at least one processor; and

a memory communicatively connected to the at least one processor; where the memory is stored with instructions executable by the at least one processor, and the instructions are executed by the at least one processor to enable the at least one processor to execute the method according to any one of the first aspect.

In a third aspect, a non-transitory computer readable storage medium stored with computer instructions is provided, where the computer instructions are configured to enable a computer to execute the method according to any one of the first aspect.

It should be understood that the content described in this section is not intended to point out the key or important features of embodiments of the present application, nor to limit the scope of the present application. Other features of the present application will be easily understood through the following description.

### BRIEF DESCRIPTION OF DRAWINGS

The drawings are used for better understanding of the present scheme and do not constitute a limitation of the present application. Among them:

FIG. 1 is a schematic diagram of a traffic flow monitoring scene provided by an embodiment of the present application;

FIG. 2 is a schematic diagram of a traffic flow state monitored by a traffic flow monitoring system provided by an embodiment of the present application;

FIG. 3 is a schematic diagram of a test scene of a traffic flow monitoring system provided by an embodiment of the present application;

FIG. 4 is a schematic flowchart of a method for testing a traffic flow monitoring system provided by an embodiment of the present application;

FIG. 5 is a schematic diagram of a testing process provided by an embodiment of the present application;

FIG. 6A is a schematic structural diagram of an apparatus for testing a traffic flow monitoring system provided by an embodiment of the present application;

FIG. 6B is a schematic structural diagram of an apparatus for testing a traffic flow monitoring system provided by another embodiment of the present application; and

FIG. 7 is a schematic structural diagram of an electronic device provided by an embodiment of the present application.

### DESCRIPTION OF EMBODIMENTS

The following describes exemplary embodiments of the present application with reference to the accompanying drawings, which includes various details of the embodiments of the present application to facilitate understanding, and the described embodiments are merely exemplary. Therefore, persons of ordinary skill in the art should know that various changes and modifications can be made to the embodiments described herein without departing from the scope and spirit of the embodiments of the present application. Also, for clarity and conciseness, descriptions of well-known functions and structures are omitted in the following description.

The present application provides a method, an apparatus and a device for test a traffic flow monitoring system, which are applied to intelligent traffic, vehicle-road collaboration, and cloud platform technologies in a field of data processing, to test a monitoring accuracy of a traffic flow monitoring system.

A vehicle-road collaboration system is a development direction of the Intelligent Traffic System (ITS). By adopting advanced wireless communication and new-generation Internet technologies and implementing dynamic and real-time information interaction between vehicles, vehicles and roads in an all-round way, and performing active vehicle safety control and road collaborative management on the basis of full-time and spatial dynamic traffic information collection and fusion, so that an effective coordination of people, vehicles and roads is fully realized, traffic safety is ensured, and traffic efficiency is improved, thereby the formed vehicle-road collaboration system is a safe, efficient and environmentally friendly road traffic system.

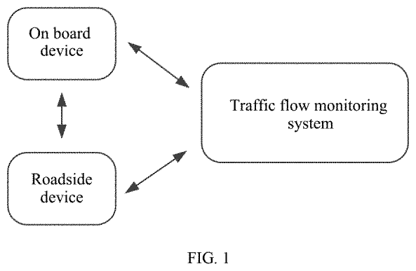

The vehicle-road coordination system may be used to monitor traffic flow. FIG. 1 is a schematic diagram of a traffic flow monitoring scene provided by an embodiment of the present application. As shown in FIG. 1, the application scene includes: an on board device, a roadside device, and a traffic flow monitoring system. The traffic flow monitoring system may be a server located in a cloud, a cloud platform, a vehicle-road system management platform, a central subsystem, etc.

As shown in FIG. 1, the on board device may be connected to the roadside device, the roadside device may be connected to the traffic flow monitoring system, and the on board device may also be directly connected to the traffic flow monitoring system. The roadside device may include a roadside sensing device and a roadside computing device, where the roadside sensing device is connected to the roadside computing device, and the roadside computing device is connected to the traffic flow monitoring system. In another system architecture, the roadside sensing device itself includes computing functions, and the roadside sensing device may be directly connected to the traffic flow monitoring system. The above connection may be wired or wireless.

In some examples, the on board device may include an on board terminal, on board units (OBU), and so on. The roadside device may include a camera, a webcam, a road side unit (RSU), a roadside computing unit, and so on. The on board device and roadside device may collect an obstacle in the current traffic scene to obtain obstacle data. Among them, the obstacles include but is not limited to: a pedestrian, a vehicle, a motorcycle, a bicycle, and so on in the traffic scene. The on board device and the roadside device report the collected obstacle data to the traffic flow monitoring system.

The traffic flow monitoring system determines the state of the traffic flow by comprehensively perceiving and analyzing the obstacle data reported by the on board device and/or roadside device. On the one hand, the traffic flow monitoring system may identify an obstacle (such as a vehicle, a pedestrian, etc.) and an obstacle trajectory. On the other hand, the traffic flow monitoring system may also identify a traffic event based on the obstacle data.

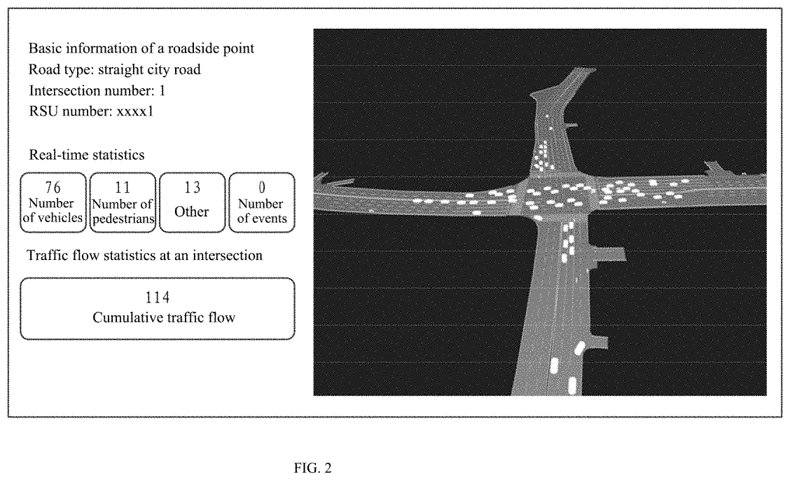

FIG. 2 is a schematic diagram of a traffic flow state monitored by a traffic flow monitoring system provided by an embodiment of the present application. As shown in FIG. 2, a visual interface is used to display a traffic flow status. Among them, the monitored traffic flow status may be visualized in real time, as shown in the right area in FIG. 2. In addition, a real-time data statistics result (such as the real-time number of vehicles, the real-time number of pedestrians, etc.) and a cumulative data statistics result (such as the cumulative number of vehicles, the cumulative number of pedestrians, etc.) may be displayed, as shown in the left area in FIG. 2. It should be noted that the display interface shown in FIG. 2 is only a possible example, and an embodiment of the present application does not limit a display form and a display content of the monitoring result of the traffic flow monitoring system.

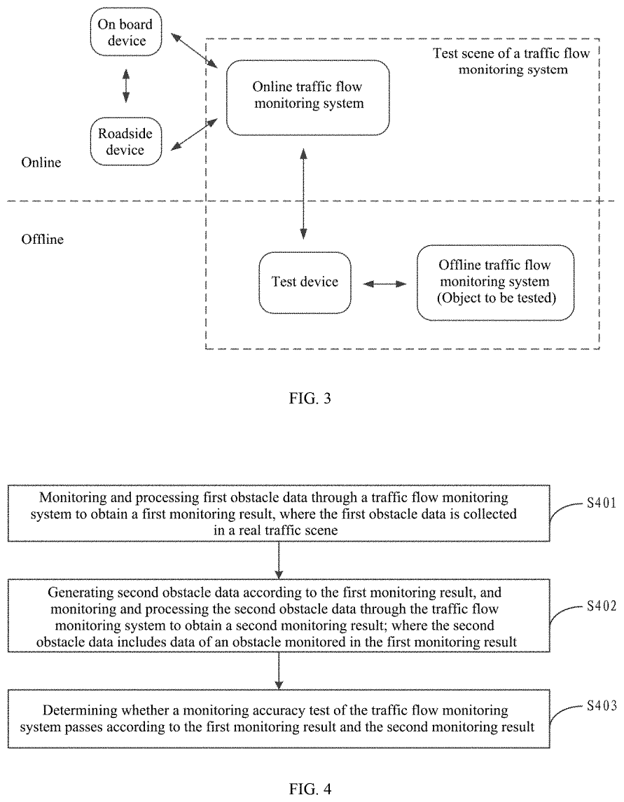

Usually, the traffic flow monitoring system needs to be tested before it goes online, and it may be tested offline. Since an offline traffic flow monitoring system does not have real data sources (that is, it is cannot to obtain obstacle data collected by the on board device and the roadside device), and the simulated obstacle data constructed by a mock tool cannot simulate a movement characteristic of an obstacle in a real traffic scene. Therefore, in order to ensure an accuracy of a test result, in some implementations, the real obstacle data collected in the real traffic scene may be used to test the traffic flow monitoring system. The following describes a test scene of the traffic flow monitoring system in combination with FIG. 3.

FIG. 3 is a schematic diagram of a test scene of a traffic flow monitoring system provided by an embodiment of the present application. As shown in FIG. 3, the test scene includes an offline traffic flow monitoring system and a test device. Among them, the offline traffic flow monitoring system is an object to be tested, and the test device is used to test the offline traffic flow monitoring system. The test device may be any electronic device with data processing and data sending/receiving function, including but not limited to a desktop computer, a notebook computer, a tablet computer, a personal computer, etc.

The test device can obtain real obstacle data collected in a real traffic scene, and send the real obstacle data to the offline traffic flow monitoring system. The test device can also obtain a monitoring result from the offline traffic flow monitoring system, so as to determine a test result based on the monitoring result.

In some possible implementations, as shown in FIG. 3, the test scene may also include an online traffic flow monitoring system. The online traffic flow monitoring system can obtain real obstacle data from an on board device, a roadside device, etc. In this way, the test device can establish a communication connection with the online traffic flow monitoring system, and obtain the real obstacle data from the online traffic flow monitoring system. Furthermore, the offline traffic flow monitoring system is tested using the real obstacle data.

In practical applications, multiple distributed nodes are usually deployed in a traffic flow monitoring system, such as distributed stream processing nodes, Kafka distributed message queues, etc., which leads a phenomenon of out-of-sequence and frame-loss after the obstacle data is processed by the above-mentioned distributed nodes in the traffic flow monitoring system. Therefore, it is necessary to implement a sorting and preventing frame-loss function in the traffic flow monitoring system to overcome the problem of out-of-sequence and frame-loss, so as to maintain an accuracy of the monitoring result as much as possible. Therefore, when testing the traffic flow monitoring system, it is necessary to test the monitoring accuracy.

In the above test scene, because the offline traffic flow monitoring system is tested using the real obstacle data collected in the real traffic scene, related information about an obstacle included in the real obstacle data is unknown. In this way, the monitoring results of the real obstacle data cannot be evaluated to obtain the monitoring accuracy. It can be seen that based on the above test scene, how to test the monitoring accuracy of the traffic flow monitoring system is a technical problem to be solved urgently.

In order to solve the above technical problem, the present application provides a method for testing a traffic flow monitoring system. In the technical solution provided by the present application, monitoring and processing first obstacle data through a traffic flow monitoring system to obtain a first monitoring result, where the first obstacle data is collected in a real traffic scene; generating second obstacle data according to the first monitoring result, and monitoring and processing the second obstacle data through the traffic flow monitoring system to obtain a second monitoring result; where the second obstacle data is data of an obstacle monitored in the first monitoring result; determining whether a monitoring accuracy test of the traffic flow monitoring system passes according to the first monitoring result and the second monitoring result, so that to realize a monitoring accuracy test of the traffic flow monitoring system.

The technical solution of the present application will be described in detail below in combination with several specific embodiments. The following embodiments can be combined with each other, and descriptions of the same or similar content may not be repeated in some embodiments.

FIG. 4 is a schematic flowchart of a method for testing a traffic flow monitoring system provided by an embodiment of the present application. As shown in FIG. 4, a method of the present embodiment includes:

S401: monitoring and processing first obstacle data through a traffic flow monitoring system to obtain a first monitoring result, where the first obstacle data is collected in a real traffic scene.

The executive body of the present embodiment may be the test device in FIG. 3. The test device is used to test the traffic flow monitoring system. The traffic flow monitoring system may be, for example, the offline traffic flow monitoring system in FIG. 3.

In the present embodiment, the test device obtains the first obstacle data collected in the real traffic scene, and monitors and processes the first obstacle data through the traffic flow monitoring system to obtain the first monitoring result.

Among them, the first obstacle data may also be referred to as real obstacle data, which includes data related to each obstacle in the real traffic scene. The obstacle in the embodiment of the present application may be a vehicle, a pedestrian, a bicycle, a motorcycle, and so on. The first obstacle data may be collected by the on board device and/or the roadside device in the real traffic scene. The form of the first obstacle data can include but is not limited to image data, video data, radar data, infrared data, point cloud data, etc., and can also be result data obtained by calculating and analyzing one or more of the above data.

In an embodiment, the first obstacle data may be obtained from an online traffic flow monitoring system. Exemplarily, in combination with the test scene shown in FIG. 3, the online traffic flow monitoring system is connected with the on board device and/or the roadside device. The on board device and/or the roadside device collects the first obstacle data in the real traffic scene, and sends the first obstacle data to the online traffic flow monitoring system. The test device establishes a communication connection with the online traffic flow monitoring system, and the test device may monitor the first obstacle data input to the online traffic flow monitoring system to obtain the first obstacle data.

Exemplarily, the test device may monitor the online traffic flow monitoring system according to the websocket protocol. The websocket is a full-duplex communication protocol based on transmission control protocol (TCP). In this way, after the test device establishes a communication connection with the online traffic flow monitoring system, if the online traffic flow monitoring system receives the first obstacle data from the on board device and/or the roadside device, it will push the first obstacle data to the test device. Thus, the test device obtains the first obstacle data.

When the traffic flow monitoring system performs perceptual analysis and processing on the obstacles, it relies on scene configuration information of the current scene. For example, the scene configuration information that needs to be relied on includes, but is not limited to: map information corresponding to the current scene, road coordinate rule information, location information of the roadside device, type information of the roadside device, and so on.

Therefore, in the present embodiment, before using the first obstacle data obtained from the online traffic flow monitoring system to test the offline traffic flow monitoring system, the scene configuration information of the online traffic flow monitoring system needs to be synchronized to the offline traffic flow monitoring system. Specifically, the test device obtains the scene configuration information of the online traffic flow monitoring system, and configures the scene configuration information to the offline traffic flow monitoring system to be tested.

In an embodiment, the first obstacle data may also be obtained from a database. Exemplarily, the database is used to store historical obstacle data collected by an on board device and/or a roadside device in each road section/area. The test device may obtain the historical obstacle data from the database according to a test requirement. These historical obstacle data are the first obstacle data.

After obtaining the first obstacle data, monitoring and processing the first obstacle data through the traffic flow monitoring system to obtain the first monitoring result. The first monitoring result indicates data of an obstacle monitored by the traffic flow monitoring system from the first obstacle data. For example, the first monitoring result may be a monitoring log output by the traffic flow monitoring system, which includes information such as an identification, a type, a movement state, and a movement trajectory of each monitored obstacle.

In some possible scenes, because the first obstacle data is monitored from the online traffic flow monitoring system, an interface rule of the online traffic flow monitoring system may be different from that of the traffic flow monitoring system to be tested. In a possible implementation, the first obstacle data may be modified according to the interface rule of the traffic flow monitoring system, so that the modified data meets an interface requirement of the traffic flow monitoring system to be tested. Furthermore, the modified data is input into the traffic flow monitoring system to obtain the first monitoring result output by the traffic flow monitoring system. It should be understood that since the modification is performed according to the interface rule of the traffic flow monitoring system, the movement characteristic of each obstacle in the first obstacle data will not be modified, thereby the authenticity of the obstacle is retained.

S402: generating second obstacle data according to the first monitoring result, and monitoring and processing the second obstacle data through the traffic flow monitoring system to obtain a second monitoring result; where the second obstacle data includes data of an obstacle monitored in the first monitoring result.

In the present embodiment, after obtaining the first monitoring result, the test device may generate the second obstacle data according to the related data of each obstacle monitored in the first monitoring result. The second obstacle data is used to input to the traffic flow monitoring system for re-monitoring processing to obtain the second monitoring result.

Among them, the second monitoring result indicates the data of the obstacle monitored by the traffic flow monitoring system from the second obstacle data. For example, the second monitoring result may be a monitoring log output by the traffic flow monitoring system, which includes information such as an identification, a type, a movement state, and a movement trajectory of each monitored obstacle.

In a possible implementation, the first monitoring result may be modified according to the interface rule of the traffic flow monitoring system to obtain the second obstacle data, so that the second obstacle data meets the interface requirement of the traffic flow monitoring system. Furthermore, the second obstacle data is input into the traffic flow monitoring system to obtain the second monitoring result output by the traffic flow monitoring system.

It should be understood that in this implementation, since the second obstacle data is obtained by modifying the first monitoring result according to the interface rule of the traffic flow monitoring system, the obstacle information described by the second obstacle data is the same as the obstacle information in the first monitoring result. For example, if the first monitoring result obtained by the traffic flow monitoring system monitoring and processing the first obstacle data in S401 includes information about 100 obstacles, the second obstacle data generated in S402 describes information about the above 100 obstacles. The difference between the second obstacle data and the first monitoring result is difference in a data format.

S403: determining whether a monitoring accuracy test of the traffic flow monitoring system passes according to the first monitoring result and the second monitoring result.

In the present embodiment, the first monitoring result and the second monitoring result may be compared, and the comparison result may indicate the monitoring accuracy of the traffic flow monitoring system. It should be understood that the more the number of obstacles that are consistent between the second monitoring result and the first monitoring result, the higher the monitoring accuracy of the traffic flow monitoring system. On the contrary, it shows that the monitoring accuracy of the traffic flow monitoring system is lower.

In the present embodiment, in order to make a more accurate assessment of the monitoring accuracy, one or more monitoring parameters may be used to quantitatively describe the monitoring accuracy. In a possible implementation, monitoring parameters may be calculated according to the first monitoring result and the second monitoring result, where the monitoring parameter includes: an accuracy rate and/or a recall rate; when the monitoring parameter is greater than or equal to a preset threshold, it is determined that the monitoring accuracy test of the traffic flow monitoring system passes. When the monitoring parameter is less than the preset threshold, it is determined that the monitoring accuracy test of the traffic flow monitoring system fails. It should be understood that when the monitoring parameters include the accuracy rate and the recall rate, the comparison thresholds corresponding to the accuracy rate and the recall rate may be the same or different, which is not limited in the present embodiment.

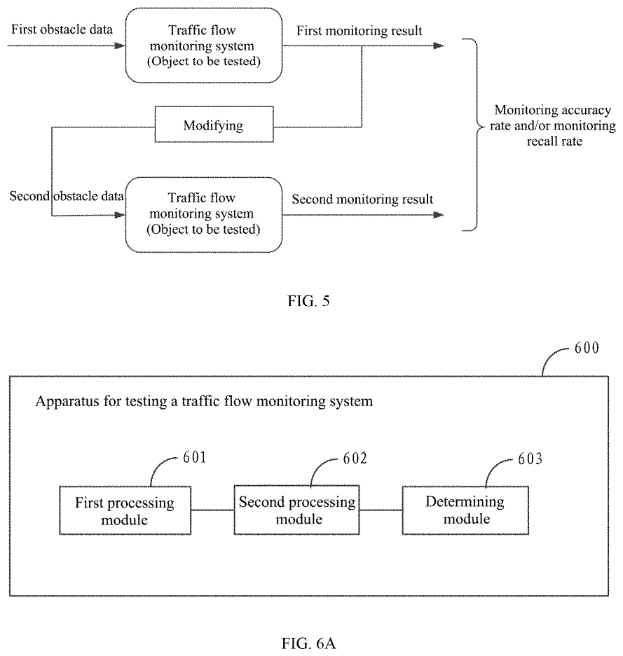

In order to understand the solution of the present embodiment more clearly, the test process in the present embodiment will be described below with reference to FIG. 5.

FIG. 5 is a schematic diagram of a testing process provided by an embodiment of the present application. As shown in FIG. 5, in the present embodiment, the offline traffic flow monitoring system needs to be used to perform two rounds of monitoring processing. The first round of monitoring processing is inputting the first obstacle data into the traffic flow monitoring system to obtain the first monitoring result. The second round of monitoring processing is inputting the second obstacle data into the traffic flow monitoring system to obtain the second monitoring result. Among them, the second obstacle data is generated according to the first monitoring result, and the second obstacle data includes data of the obstacle monitored in the first monitoring result.

Continuing to refer to FIG. 5, after the above two rounds of monitoring processing, the second monitoring result is compared with the first monitoring result to determine the monitoring accuracy rate and/or monitoring recall rate of the traffic flow monitoring system. It should be noted that the present embodiment does not limit a calculation method of the monitoring accuracy rate and the monitoring recall rate, and the following embodiments will be described in detail in combination with specific examples.

The reasons why two rounds of monitoring processing are required in the present embodiment will be explained below. For the first round of monitoring and processing, inputting the first obstacle data into the traffic flow monitoring system to obtain the first monitoring result, since the first obstacle data is collected from the real traffic scene, the related information of the obstacle included in the first obstacle data is unknown. Therefore, the monitoring accuracy rate and the monitoring recall rate cannot be determined based on the first monitoring result alone.

In the embodiment of the present application, after the first monitoring result is obtained, the second obstacle data is generated according to the first monitoring result, and the second obstacle data is input into the traffic flow monitoring system for the second round of monitoring processing to obtain the second monitoring result. Since the second obstacle data is generated based on the first monitoring result, the second obstacle data includes the data of each obstacle monitored in the first monitoring result. Therefore, for the second round of monitoring processing, the first monitoring result is equivalent to an input of the traffic flow monitoring system, and the second monitoring result is an output of the traffic flow monitoring system. Since the related information of the obstacle in the first monitoring result is known after the first round of monitoring processing, the monitoring accuracy rate and the monitoring recall rate can be determined based on the first monitoring result and the second monitoring result.

The method for testing a traffic flow monitoring system provided in the present embodiment includes: monitoring and processing first obstacle data through a traffic flow monitoring system to obtain a first monitoring result, where the first obstacle data is collected in a real traffic scene; generating second obstacle data according to the first monitoring result, and monitoring and processing the second obstacle data through the traffic flow monitoring system to obtain a second monitoring result; where the second obstacle data includes data of an obstacle monitored in the first monitoring result; and determining whether a monitoring accuracy test of the traffic flow monitoring system passes according to the first monitoring result and the second monitoring result. Through the above process, the monitoring accuracy test of the traffic flow monitoring system is realized.

In actual application scenes, the traffic flow monitoring system may realize an obstacle recognition processing and/or a traffic event recognition processing. On the basis of the foregoing embodiment, the following describes how to determine an accuracy of the obstacle recognition processing and how to determine the accuracy of an accuracy of the traffic event recognition processing in combination with two specific examples.

In an example, for the scene of the obstacle recognition processing by the traffic flow monitoring system. The first monitoring result includes a first obstacle list, where the first obstacle list includes identifications of each obstacle obtained by the traffic flow monitoring system performing obstacle recognition on the first obstacle data. The second monitoring result includes a second obstacle list, where the second obstacle list includes identifications of each obstacle obtained by the traffic flow monitoring system performing obstacle recognition on the second obstacle data. In this way, an accuracy rate and/or a recall rate of the obstacle recognition can be calculated according to the first obstacle list and the second obstacle list. Further, the accuracy of the obstacle recognition processing can be determined according to the accuracy and/or recall rate of the obstacle recognition.

Exemplarily, the first obstacle list={obstacle 1, obstacle 2, obstacle 3, . . . , obstacle n},

the second obstacle list={obstacle 1, obstacle 2, obstacle 3, . . . , obstacle m}.

In an embodiment, since information of an obstacle in a real traffic scene may be collected multiple times, there may be duplicate obstacles in the first obstacle list or in the second obstacle list. It is possible to delete the duplicate obstacles in the first obstacle list, and delete the duplicate obstacles in the second obstacle list to ensure the accuracy of the test result.

The following methods may be used to calculate the accuracy rate and the recall rate of the obstacle recognition:

(1) obtaining the number of a first target obstacle according to the first obstacle list and the second obstacle list, where the first target obstacle refer to the obstacle whose identification located in the first obstacle list and located in the second obstacle list. In other words, for each obstacle in the second obstacle list, if the obstacle also appears in the first obstacle list, the obstacle is determined as the first target obstacle. In this way, the number of the first target obstacle can be counted.

(2) calculating the accuracy rate of the obstacle recognition according to the number of the first target obstacle and the number of the obstacle in the second obstacle list. Exemplarily, the following formula can be used to calculate the accuracy rate of the obstacle recognition:

$$The accuracy rate of the obstacle recognition = \frac{The number of the first target obstacle}{The number of the obstacle in the second obstacle list}$$

(3) calculating the recall rate of the obstacle recognition according to the number of the first target obstacle and the number of the obstacle in the first obstacle list. Exemplarily, the following formula can be used to calculate the recall rate of the obstacle recognition:

$$The recall rate of the obstacle recognition = \frac{The number of the first target obstacle}{The number of the obstacle in the first obstacle list}$$

In a possible implementation, during the obstacle recognition processing, the traffic flow monitoring system also identifies trajectory information of the obstacle. Therefore, in the present embodiment, an accuracy rate and/or a recall rate of obstacle trajectory recognition can also be calculated.

Specifically, the first obstacle list includes the identifications of each obstacle and the trajectory information of each obstacle obtained by the obstacle recognition of the first obstacle data by the traffic flow monitoring system. The second obstacle list includes the identifications of each obstacle and the trajectory information of each obstacle obtained by the obstacle recognition of the second obstacle data by the traffic flow monitoring system. In this way, the accuracy rate and/or the recall rate of obstacle trajectory recognition can be calculated according to the first obstacle list and the second obstacle list.

Exemplarily, the first obstacle list={(obstacle 1, trajectory information 1), (obstacle 2, trajectory information 2), (obstacle 3, trajectory information 3), . . . , (obstacle n, trajectory information n)},

the second obstacle list={(obstacle 1, trajectory information 1), (obstacle 2, trajectory information 2), (obstacle 3, trajectory information 3), . . . , (obstacle m, trajectory information m)}.

In an embodiment, the trajectory information of each obstacle may include the heading angle sequence corresponding to the obstacle.

The following methods may be used to obtain the accuracy rate and the recall rate of the obstacle trajectory recognition:

(1) obtaining the number of a second target obstacle according to the first obstacle list and the second obstacle list, where the second target obstacle satisfies the following conditions: its identification is located in the first obstacle list and is located in the second obstacle list, and its trajectory information in the second obstacle list is the same as the trajectory information in the first obstacle list. In other words, for each obstacle in the second obstacle list, if the obstacle also appears in the first obstacle list, and the trajectory information of the obstacle in the second obstacle list is the same as that in the first obstacle list, then the obstacle is determined as a second target obstacle. In this way, the number of the second target obstacle can be counted.

(2) calculating the accuracy rate of the obstacle trajectory recognition according to the number of the second target obstacle and the number of the obstacle in the second obstacle list. Exemplarily, the following formula can be used to calculate the accuracy rate of the obstacle trajectory recognition:

$$The accuracy rate of the obstacle trajectory recognition = \frac{The number of the second target obstacle}{The number of the obstacle in the second obstacle list}$$

(3) calculating the recall rate of the obstacle trajectory recognition according to the number of the second target obstacle and the number of the obstacle in the first obstacle list. Exemplarily, the following formula can be used to calculate the recall rate of the obstacle trajectory recognition:

$$The recall rate of the obstacle trajectory recognition = \frac{The number of the second target obstacle}{The number of the obstacle in the first obstacle list}$$

In another example, for the scene of the traffic event recognition processing by the traffic flow monitoring system. The first monitoring result includes a first traffic event list, where the first traffic event list includes identifications of each traffic event obtained by the traffic flow monitoring system performing traffic event recognition on the first obstacle data. The second monitoring result includes a second traffic event list, where the second traffic event list includes the identifications of each traffic event obtained by the traffic flow monitoring system performing traffic event recognition on the second obstacle data. In this way, an accuracy rate and/or a recall rate of the traffic event recognition can be calculated according to the first traffic event list and the second traffic event list. Furthermore, the accuracy of the traffic event recognition processing can be determined according to the accuracy rate and/or the recall rate of the traffic event recognition.

Exemplarily, the first traffic event list={traffic event 1, traffic event 2, traffic event 3, . . . , traffic event n},

the second traffic event list={traffic event 1, traffic event 2, traffic event 3, . . . , traffic event m}.

In an embodiment, since information of certain obstacles in a real traffic scene may be collected multiple times, so that the traffic flow monitoring system may identify duplicate traffic events. It is possible to delete the duplicate traffic events in the first traffic event list, and delete the duplicate traffic events in the second traffic event list to ensure the accuracy of the test result.

The following methods can be used to determine the accuracy rate and the recall rate of the traffic event recognition:

(1) obtaining the number of a target traffic event according to the first traffic event list and the second traffic event list, where the identification of the target traffic event is located in the first traffic event list and located in the second traffic event list. In other words, for each traffic event in the second traffic event list, if the traffic event also appears in the first traffic event list, the traffic event is determined as the target traffic event. In this way, the number of the target traffic event can be counted.

(2) calculating the accuracy rate of the traffic event recognition according to the number of the target traffic event and the number of the traffic event in the second traffic event list. Exemplarily, the following formula can be used to calculate the accuracy rate of the traffic event recognition:

$$The accuracy rate of the traffic event recognition = \frac{The number of the target traffic event}{The number of the traffic event in the second traffic event list}$$

(3) calculating the recall rate of the traffic event recognition according to the number of the target traffic event and the number of the traffic event in the first traffic event list. Exemplarily, the following formula can be used to calculate the recall rate of the traffic event recognition:

$$The accuracy rate of the traffic event recognition = \frac{The number of the target traffic event}{The number of the traffic event in the first traffic event list}$$

In the present embodiment, monitoring and processing the first obstacle data through the traffic flow monitoring system to obtain a first monitoring result, generating second obstacle data according to the first monitoring result, and monitoring and processing the second obstacle data through the traffic flow monitoring system to obtain a second monitoring result; and determining whether a monitoring accuracy test of the traffic flow monitoring system passes according to the first monitoring result and the second monitoring result. Through the above process, the monitoring accuracy test of the traffic flow monitoring system is realized. Further, by calculating the monitoring parameter according to the first monitoring result and the second monitoring result, it is possible to determine whether the monitoring accuracy test passes or not according to the monitoring parameters to ensure the accuracy of the test result.

FIG. 6A is a schematic structural diagram of an apparatus for testing a traffic flow monitoring system provided by an embodiment of the present application. The apparatus in the present embodiment may be in a form of software and/or hardware, and the apparatus may be used as a test device or integrated into a test device. As shown in FIG. 6A, the apparatus for testing a traffic flow monitoring system 600 provided in the present embodiment includes: a first processing module 601, a second processing module 602, and a determining module 603.

Among them, the first processing module 601, configured to monitor and process first obstacle data through the traffic flow monitoring system to obtain a first monitoring result, where the first obstacle data is collected in a real traffic scene;

the second processing module 602, configured to generate second obstacle data according to the first monitoring result, and monitor and process the second obstacle data through the traffic flow monitoring system to obtain a second monitoring result; where the second obstacle data includes data of an obstacle monitored in the first monitoring result; and

the determining module 603, configured to determine whether a monitoring accuracy test of the traffic flow monitoring system passes according to the first monitoring result and the second monitoring result.

The apparatus provided in the present embodiment may be used to implement the technical solution in the method embodiment shown in FIG. 4, and their implementation principles and technical effects are similar, and will not be repeated here.

FIG. 6B is a schematic structural diagram of an apparatus for testing a traffic flow monitoring system provided by an embodiment of the present application, on the basis of FIG. 6A, in the present embodiment, the determining module 603 may include a calculating unit 6031 and a determining unit 6032.

Among them, the calculating unit 6031 is configured to calculate a monitoring parameter according to the first monitoring result and the second monitoring result, where the monitoring parameter includes: an accuracy rate and/or a recall rate; and

the determining unit 6032 is configured to determine that the monitoring accuracy test of the traffic flow monitoring system passes when the monitoring parameter is greater than or equal to a preset threshold.

In a possible implementation, the monitoring and processing includes an obstacle recognition processing; the first monitoring result includes a first obstacle list, where the first obstacle list includes identifications of each obstacle obtained by the traffic flow monitoring system performing obstacle recognition on the first obstacle data;

the second monitoring result includes a second obstacle list, where the second obstacle list includes identifications of each obstacle obtained by the traffic flow monitoring system performing obstacle recognition on the second obstacle data;

the calculating unit 6031 is specifically configured to calculate an accuracy rate and/or a recall rate of the obstacle recognition according to the first obstacle list and the second obstacle list.

In a possible implementation, the calculating unit 6031 is specifically configured to:

obtain a number of a first target obstacle according to the first obstacle list and the second obstacle list, where an identification of the first target obstacle is located in the first obstacle list and located in the second obstacle list;

calculate the accuracy rate of the obstacle recognition according to the number of the first target obstacle and a number of an obstacle in the second obstacle list; and/or,

calculate the recall rate of the obstacle recognition according to the number of the first target obstacle and a number of an obstacle in the first obstacle list.

In a possible implementation, the first obstacle list further includes trajectory information of each obstacle in the first obstacle list; and the second obstacle list further includes trajectory information of each obstacle in the second obstacle list; and the calculating unit 6031 is specifically configured to:

calculate an accuracy rate and/or a recall rate of obstacle trajectory recognition according to the first obstacle list and the second obstacle list.

In a possible implementation, the calculating unit 6031 is specifically configured to:

obtain a number of a second target obstacles according to the first obstacle list and the second obstacle list, where an identification of the second target obstacle is located in the first obstacle list and located in the second obstacle list, where trajectory information of the second target obstacle in the second obstacle list is the same as trajectory information of the second target obstacle in the first obstacle list;

calculate the accuracy rate of the obstacle trajectory recognition according to the number of the second target obstacle and a number of an obstacle in the second obstacle list; and/or,

calculate the recall rate of the obstacle trajectory recognition according to the number of the second target obstacle and a number of an obstacle in the first obstacle list.

In a possible implementation, the monitoring and processing includes a traffic event recognition processing, the first monitoring result includes a first traffic event list, where the first traffic event list includes identifications of each traffic event obtained by the traffic flow monitoring system performing traffic event recognition on the first obstacle data;

the second monitoring result includes: a second traffic event list, where the second traffic event list includes the identifications of each traffic event obtained by the traffic flow monitoring system performing traffic event recognition on the second obstacle data;

the calculating unit 6031 is specifically configured to: calculate an accuracy rate and/or a recall rate of the traffic event recognition according to the first traffic event list and the second traffic event list.

In a possible implementation, the calculating unit 6031 is specifically configured to:

obtain a number of a target traffic event according to the first traffic event list and the second traffic event list, where an identification of the target traffic event is located in the first traffic event list and located in the second traffic event list;

calculate the accuracy rate of the traffic event recognition according to the number of the target traffic event and a number of a traffic event in the second traffic event list; and/or,

calculate the recall rate of the traffic event recognition according to the number of the target traffic event and a number of a traffic event in the first traffic event list.

In a possible implementation, the first processing module 601 is specifically configured to:

modify the first obstacle data according to an interface rule of the traffic flow monitoring system; and

input the modified data into the traffic flow monitoring system to obtain the first monitoring result output by the traffic flow monitoring system.

In a possible implementation, the second processing module 602 is specifically configured to:

modify the first monitoring result according to an interface rule of the traffic flow monitoring system to obtain the second obstacle data; and

input the second obstacle data into the traffic flow monitoring system to obtain the second monitoring result output by the traffic flow monitoring system.

The apparatus of the present embodiment can be used to execute the technical solutions in any of the foregoing method embodiments, and their implementation principles and technical effects are similar, and will not be repeated here.

According to the embodiments of the present application, the present application also provides an electronic device and a readable storage medium. The electronic device can be used as a test device to test the traffic flow monitoring system.

According to an embodiment of the present application, the present application also provides a computer program product, where the computer program product includes a computer program, and a computer program is stored in a readable storage medium, at least one processor of the electronic device can read the computer program from the readable storage medium, and at least one processor executes the computer program to make the electronic device execute the solution provided by any of the above embodiments.

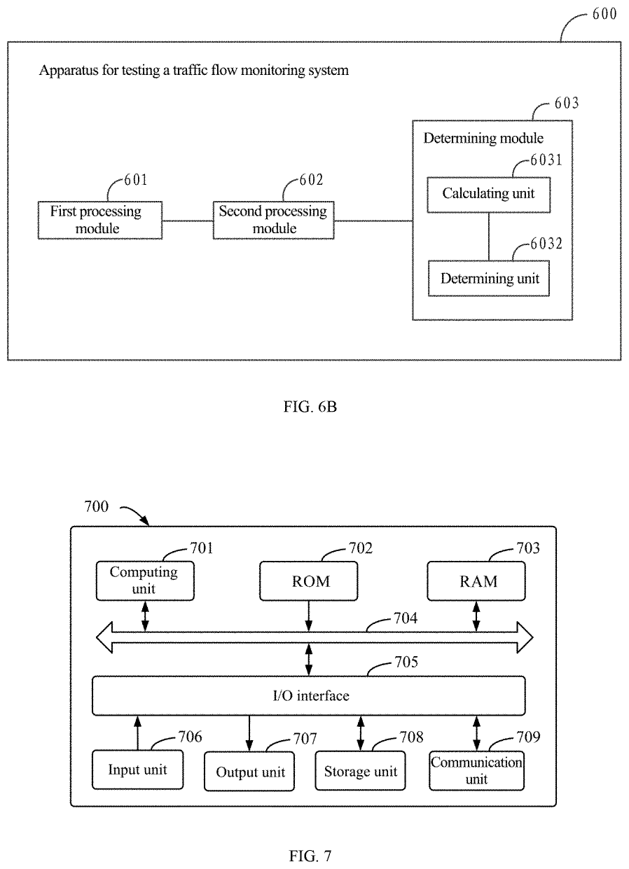

FIG. 7 shows a schematic block diagram of an example electronic device 700 which can be used to implement embodiments of the present application. The electronic device is intended to represent various forms of digital computers, such as a laptop computer, a desktop computer, a workbench, a personal digital assistant, a server, a blade server, a mainframe computer, and other suitable computers. The electronic device can also represent various forms of mobile apparatus, such as a personal digital assistant, a cellular phone, a smart phone, a wearable device, and other similar computing apparatus. The components, their connections and relationships, and their functions herein are merely examples, and are not intended to limit an implementation of the present application described and/or claimed herein.

As shown in FIG. 7, the electronic device 700 includes a computing unit 701, which may perform various appropriate actions and processes according to a computer program stored in a read-only memory (ROM) 702 or a computer program loaded from a storage unit 708 into a random access memory (RAM) 703. In the RAM 703, various programs and data required for the operation of the electronic device 700 may also be stored. The computing unit 701, the ROM 702, and the RAM 703 are connected to each other through a bus 704. An input/output (I/O) interface 705 is also connected to the bus 704.

Multiple components in the device 700 are connected to the I/O interface 705, including: an inputting unit 706, such as a keyboard, a mouse, etc.; an outputting unit 707, such as various types of displays, speakers, etc.; and a storage unit 708, such as a magnetic disk, an optical disk, etc.; and a communication unit 709, such as an network card, a modem, a wireless communication transceiver, etc. The communication unit 709 allows the device 700 to exchange information/data with other devices through a computer network such as the Internet and/or various telecommunication networks.

The computing unit 701 may be various general and/or special-purpose processing components with processing and computing capabilities. Some examples of the computing unit 701 include, but are not limited to, a central processing unit (CPU), a graphics processing unit (GPU), various dedicated artificial intelligence (AI) computing chips, various computing units that run machine learning model algorithms, and digital signal processing (DSP), as well as any appropriate processor, a controller, a microcontroller, etc. The computing unit 701 executes the various methods and processes described above, such as the method for testing a traffic flow monitoring system. For example, in some embodiments, the method for testing a traffic flow monitoring system be implemented as a computer software program, which is tangibly contained in a machine-readable medium, such as the storage unit 708. In some embodiments, part or all of the computer program may be loaded and/or installed on the device 700 via the ROM 702 and/or the communication unit 709. When the computer program is loaded into the RAM 703 and executed by the computing unit 701, one or more steps of the method for testing a traffic flow monitoring system described above may be executed. Alternatively, in other embodiments, the computing unit 701 may be configured to execute the method for testing a traffic flow monitoring system through any other suitable means (for example, by a firmware).

The various implementations of the systems and technologies described above in this article can be implemented in a digital electronic circuit system, an integrated circuit system, a field programmable gate array (FPGA), an application-specific integrated circuit (ASIC), an application-specific standard product (ASSP), a system on chip system (SOC), a complex programming logic device (CPLD), a computer hardware, a firmware, a software, and/or a combination thereof. These various embodiments may include: being implemented in one or more computer programs, the one or more computer programs may be executed and/or interpreted on a programmable system including at least one programmable processor, the programmable processor may be a dedicated or general-purpose programmable processor that can receive data and instructions from a storage system, at least one input device, and at least one output device, and transmit data and instructions to the storage system, the at least one input device, and the at least one output device.

The program code used to implement the method of the present application can be written in any combination of one or more programming languages. The program code can be provided to a processor or a controller of a general-purpose computer, a special-purpose computer, or other programmable data processing apparatus, so that when the program code is executed by the processor or the controller, functions specified in the flowcharts and/or block diagrams are implemented. The program code may be executed entirely on a machine, partly executed on the machine, partly executed on the machine and partly executed on a remote machine as an independent software package, or entirely executed on a remote machine or a server.

In the context of the present application, a machine-readable medium may be a tangible medium, which may contain or store a program for use by an instruction execution system, apparatus, or device or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or a semiconductor system, apparatus, or device, or any suitable combination of the foregoing. More specific examples of the machine-readable storage media would include electrical connections based on one or more wires, a portable computer disk, a hard disk, a random access memory (RAM), a read-only memory (ROM), a erasable programmable read-only memory (EPROM or flash memory), an optical fiber, a portable compact disk read-only memory (CD-ROM), an optical storage device, a magnetic storage device, or any suitable combination of the foregoing.

In order to provide interaction with users, the systems and techniques described herein may be implemented on a computer, where the computer has: a display apparatus (for example, a CRT (cathode ray tube) or an LCD (liquid crystal display) monitor) for displaying information to users; and a keyboard and a pointing apparatus (for example, a mouse or a trackball) though which users may provide input to the computer. Other types of apparatus may also be used to provide interaction with users; for example, the feedback provided to users may be any form of sensing feedback (for example, visual feedback, audible feedback, or tactile feedback); and the input from users may be received in any form (including sound input, voice input, or tactile input).

The systems and techniques described herein may be implemented in a computing system that includes a back end component (for example, a data server), or a computing system that includes a middleware component (for example, an application server), or a computing system that includes a front end component (for example, a user computer with a graphical user interface or a web browser, through which the user can interact with the implementations of the systems and techniques described herein), or a computing system that includes any combination of such back end component, middleware component, or front end component. System components may be connected to each other by any form or medium of digital data communication (for example, a communication network). Examples of the communication network include: a local area network (LAN), a wide area network (WAN) and Internet.

A computer system may include a client and a server. The client and the server are generally far from each other and usually perform interactions through a communication network. A relationship between the client and the server is generated by a computer program running on corresponding computers and having a client-server relationship. The server may be a cloud server, also known as a cloud computing server or a cloud host, which is a host product in the cloud computing service system to solve the disadvantages of difficult management and weak business scalability in a traditional physical host and Virtual Private Server (VPS for short) service. The server may also be a server of a distributed system, or a server combined with a blockchain.

It should be understood that various forms of processes shown above can be used, and steps may be reordered, added, or deleted. For example, the steps described in the present application may be performed in parallel or sequentially or in different orders. As long as desired results of the technical solutions disclosed in the present application can be achieved, no limitation is made herein.

The above specific embodiments do not constitute a limitation to the protection scope of the present application. Persons skilled in the art should know that various modifications, combinations, sub-combinations and substitutions can be made according to design requirements and other factors. Any modification, equivalent replacement and improvement made within the spirit and principle of the present application shall be included in the protection scope of the present application.

What is claimed is:

1. A method for testing a traffic flow monitoring system, comprising:
monitoring and processing first obstacle data through the traffic flow monitoring system to obtain a first monitoring result, wherein the first obstacle data is collected in a real traffic scene;
generating second obstacle data according to the first monitoring result, and monitoring and processing the second obstacle data through the traffic flow monitoring system to obtain a second monitoring result; wherein the second obstacle data comprises data of an obstacle monitored in the first monitoring result; and
determining whether a monitoring accuracy test of the traffic flow monitoring system passes according to the first monitoring result and the second monitoring result.

2. The method according to claim 1, wherein the determining whether the monitoring accuracy test of the traffic flow monitoring system passes according to the first monitoring result and the second monitoring result comprises:
calculating a monitoring parameter according to the first monitoring result and the second monitoring result, wherein the monitoring parameter comprises an accuracy rate and/or a recall rate; and
determining that the monitoring accuracy test of the traffic flow monitoring system passes when the monitoring parameter is greater than or equal to a preset threshold.

3. The method according to claim 2, wherein the monitoring and processing comprises an obstacle recognition processing; the first monitoring result comprises a first obstacle list, wherein the first obstacle list comprises identifications of each obstacle obtained by the traffic flow monitoring system performing obstacle recognition on the first obstacle data;
the second monitoring result comprises a second obstacle list, wherein the second obstacle list comprises identifications of each obstacle obtained by the traffic flow monitoring system performing obstacle recognition on the second obstacle data;
the calculating the monitoring parameter according to the first monitoring result and the second monitoring result comprises:
calculating an accuracy rate and/or a recall rate of the obstacle recognition according to the first obstacle list and the second obstacle list.

4. The method according to claim 3, wherein the calculating the accuracy rate and/or the recall rate of the obstacle recognition according to the first obstacle list and the second obstacle list comprises:
obtaining a number of a first target obstacle according to the first obstacle list and the second obstacle list, wherein an identification of the first target obstacle is located in the first obstacle list and located in the second obstacle list;
calculating the accuracy rate of the obstacle recognition according to the number of the first target obstacle and a number of an obstacle in the second obstacle list; and/or, calculating the recall rate of the obstacle recognition according to the number of the first target obstacle and a number of an obstacle in the first obstacle list.

5. The method according to claim 3, wherein the first obstacle list further comprises trajectory information of each obstacle in the first obstacle list; and the second obstacle list further comprises trajectory information of each obstacle in the second obstacle list;
the calculating the monitoring parameter according to the first monitoring result and the second monitoring result further comprises:
calculating an accuracy rate and/or a recall rate of obstacle trajectory recognition according to the first obstacle list and the second obstacle list.

6. The method according to claim 5, wherein the calculating the accuracy rate and/or the recall rate of the obstacle trajectory recognition according to the first obstacle list and the second obstacle list comprises:
obtaining a number of a second target obstacle according to the first obstacle list and the second obstacle list, wherein an identification of the second target obstacle is located in the first obstacle list and located in the second obstacle list, wherein trajectory information of the second target obstacle in the second obstacle list is the same as trajectory information of the second target obstacle in the first obstacle list;
calculating the accuracy rate of the obstacle trajectory recognition according to the number of the second target obstacle and a number of an obstacle in the second obstacle list; and/or, calculating the recall rate of the obstacle trajectory recognition according to the number of the second target obstacle and a number of an obstacle in the first obstacle list.

7. The method according to claim 2, wherein the monitoring and processing comprises a traffic event recognition processing, the first monitoring result comprises a first traffic event list, wherein the first traffic event list comprises identifications of each traffic event obtained by the traffic flow monitoring system performing traffic event recognition on the first obstacle data;
the second monitoring result comprises a second traffic event list, wherein the second traffic event list comprises identifications of each traffic event obtained by the traffic flow monitoring system performing traffic event recognition on the second obstacle data;
the calculating the monitoring parameter according to the first monitoring result and the second monitoring result comprises:
calculating an accuracy rate and/or a recall rate of the traffic event recognition according to the first traffic event list and the second traffic event list.

8. The method according to claim 7, wherein the calculating the accuracy rate and/or the recall rate of the traffic event recognition according to the first traffic event list and the second traffic event list comprises:
obtaining a number of a target traffic event according to the first traffic event list and the second traffic event list, wherein an identification of the target traffic event is located in the first traffic event list and located in the second traffic event list;
calculating the accuracy rate of the traffic event recognition according to the number of the target traffic event and a number of a traffic event in the second traffic event list; and/or, calculating the recall rate of the traffic event recognition according to the number of the target traffic event and a number of a traffic event in the first traffic event list.

9. The method according to claim 1, wherein the monitoring and processing first obstacle data through the traffic flow monitoring system to obtain the first monitoring result comprises:
modifying the first obstacle data according to an interface rule of the traffic flow monitoring system; and
inputting the modified data into the traffic flow monitoring system to obtain the first monitoring result output by the traffic flow monitoring system.

10. The method according to claim 1, wherein the generating the second obstacle data according to the first monitoring result, and monitoring and processing the second obstacle data through the traffic flow monitoring system to obtain the second monitoring result comprises:
modifying the first monitoring result according to an interface rule of the traffic flow monitoring system to obtain the second obstacle data; and
inputting the second obstacle data into the traffic flow monitoring system to obtain the second monitoring result output by the traffic flow monitoring system.

11. An electronic device, comprising:
at least one processor; and
a memory communicatively connected to the at least one processor;
wherein the memory is stored with instructions executable by the at least one processor, and the instructions are executed by the at least one processor to enable the at least one processor to:
monitor and process first obstacle data through the traffic flow monitoring system to obtain a first monitoring result, wherein the first obstacle data is collected in a real traffic scene;
generate second obstacle data according to the first monitoring result, and monitor and process the second obstacle data through the traffic flow monitoring system to obtain a second monitoring result; wherein the second obstacle data comprises data of an obstacle monitored in the first monitoring result; and
determine whether a monitoring accuracy test of the traffic flow monitoring system passes according to the first monitoring result and the second monitoring result.

12. The electronic device according to claim 11, wherein the at least one processor is further configured to:
calculate a monitoring parameter according to the first monitoring result and the second monitoring result, wherein the monitoring parameter comprises an accuracy rate and/or a recall rate; and
determine that the monitoring accuracy test of the traffic flow monitoring system passes when the monitoring parameter is greater than or equal to a preset threshold.

13. The electronic device according to claim 12, wherein the monitoring and processing comprises an obstacle recognition processing; the first monitoring result comprises a first obstacle list, wherein the first obstacle list comprises identifications of each obstacle obtained by the traffic flow monitoring system performing obstacle recognition on the first obstacle data;
the second monitoring result comprises a second obstacle list, wherein the second obstacle list comprises identifications of each obstacle obtained by the traffic flow monitoring system performing obstacle recognition on the second obstacle data;
the at least one processor is further configured to:
calculate an accuracy rate and/or a recall rate of the obstacle recognition according to the first obstacle list and the second obstacle list.

14. The electronic device according to claim 13, wherein the at least one processor is further configured to:
obtain a number of a first target obstacle according to the first obstacle list and the second obstacle list, wherein an identification of the first target obstacle is located in the first obstacle list and located in the second obstacle list;
calculate the accuracy rate of the obstacle recognition according to the number of the first target obstacle and a number of an obstacle in the second obstacle list; and/or, calculate the recall rate of the obstacle recognition according to the number of the first target obstacle and a number of an obstacle in the first obstacle list.

15. The electronic device according to claim 13, wherein the first obstacle list further comprises trajectory information of each obstacle in the first obstacle list; and the second obstacle list further comprises trajectory information of each obstacle in the second obstacle list; and the at least one processor is further configured to:
calculate an accuracy rate and/or a recall rate of obstacle trajectory recognition according to the first obstacle list and the second obstacle list.

16. The electronic device according to claim 15, wherein the at least one processor is further configured to:
obtain a number of a second target obstacle according to the first obstacle list and the second obstacle list, wherein an identification of the second target obstacle is located in the first obstacle list and located in the second obstacle list, wherein trajectory information of the second target obstacle in the second obstacle list is the same as trajectory information of the second target obstacle in the first obstacle list;
calculate the accuracy rate of the obstacle trajectory recognition according to the number of the second target obstacle and a number of an obstacle in the second obstacle list; and/or, calculate the recall rate of the obstacle trajectory recognition according to the number of the second target obstacle and a number of an obstacle in the first obstacle list.

17. The electronic device according to claim 12, wherein the monitoring and processing comprises a traffic event recognition processing, the first monitoring result comprises a first traffic event list, wherein the first traffic event list comprises identifications of each traffic event obtained by the traffic flow monitoring system performing traffic event recognition on the first obstacle data;
the second monitoring result comprises a second traffic event list, wherein the second traffic event list comprises the identifications of each traffic event obtained by the traffic flow monitoring system performing traffic event recognition on the second obstacle data;
the at least one processor is further configured to: calculate an accuracy rate and/or a recall rate of the traffic event recognition according to the first traffic event list and the second traffic event list.

18. The electronic device according to claim 17, wherein the at least one processor is specifically configured to:
obtain a number of a target traffic event according to the first traffic event list and the second traffic event list, wherein an identification of the target traffic event is located in the first traffic event list and located in the second traffic event list;
calculate the accuracy rate of the traffic event recognition according to the number of the target traffic event and a number of a traffic event in the second traffic event list; and/or, calculate the recall rate of the traffic event recognition according to the number of the target traffic event and a number of a traffic event in the first traffic event list.

19. The electronic device according to claim 11, wherein the at least one processor is specifically configured to:
modify the first obstacle data according to an interface rule of the traffic flow monitoring system; and
input the modified data into the traffic flow monitoring system to obtain the first monitoring result output by the traffic flow monitoring system.

20. A non-transitory computer readable storage medium stored with computer instructions, wherein the computer instructions are configured to enable a computer to execute the method according to claim 1.
